(19) United States
(12) Patent Application Publication
(10) Pub. No.: US 2018/0077123 A1
(43) Pub. Date: Mar. 15, 2018

(54) DATA MANAGEMENT APPARATUS, DATA MANAGEMENT METHOD AND COMPUTER READABLE RECORDING MEDIUM

(71) Applicant: NEC Solution Innovators, Ltd., Koto-ku, Tokyo (JP)

(72) Inventor: JUN NODA, Tokyo (JP)

(73) Assignee: NEC Solution Innovators, Ltd., Koto-ku, Tokyo (JP)

(21) Appl. No.: 15/559,888

(22) PCT Filed: Mar. 25, 2016
(86) PCT No.: PCT/JP2016/059555

§ 371 Date: Sep. 20, 2017

(30) Foreign Application Priority Data
Mar. 27, 2015 (JP) 2015-066878

(51) Int. Cl. H04L 29/06; G06F 21/60

(52) U.S. Cl. CPC H04L 63/0428; G06F 21/602

(57) ABSTRACT

A data management apparatus (10) is for managing data shared by a plurality of users. The data management apparatus (10) includes: an encryption processing unit (11) that encrypts the shared data; a coordinate acquisition unit (12) that, when one of the plurality of users has transmitted coordinates that have been pre-allocated thereto together with a request for decryption of the shared data, requests each of remaining users to transmit coordinates that have been pre-allocated thereto; and a decryption processing unit (13) that, when each of the remaining users has transmitted the coordinates that have been pre-allocated thereto, calculates a function from the coordinates transmitted by one user and the coordinates transmitted by the remaining users, and decrypts the encrypted shared data using a value obtained from the calculated function as a decryption key.

### TECHNICAL FIELD

The present invention relates to a data management apparatus and a data management method for managing a database, and to a computer-readable recording medium having recorded therein a program for realizing these apparatus and method.

### BACKGROUND ART

In general, food is supplied to consumers via complicated distribution channels. Especially, distribution channels for processed food are even more complicated, because processed food needs to be processed by ingredient manufacturers, processors, and so forth.

Food safety is relevant to the health of consumers. If any problem arises, it is necessary to identify in which part of the distribution channels the cause of the problem resides. To this end, the records of companies need to be searched on a company-by-company basis, from the most downstream company to the most upstream company. For this reason, identification of the cause of the problem requires a great deal of manpower and time in the current situation.

One possible solution to the foregoing issue is to provide a database on a channel directly connecting an upstream company and a downstream company in such a manner that the two companies share the database and data content therein. Specifically, for example, data of company A that manufactures processed food and data of company B that supplies ingredients to company A can be shared by providing a database to be shared by these companies on a channel connecting these companies.

Assume, in this case, that a problem has occurred in processed food sold by company A. Company A can immediately analyze whether the problem has arisen in their own company or in company B by checking data of company B stored in the shared database.

Such a shared database can be realized by, for example, a system disclosed in Patent Document 1. The system disclosed in Patent Document 1 allows specific data to be safely shared by two organizations.

### LIST OF PRIOR ART DOCUMENTS

### Patent Document

Patent Document 1: JP H10-111897A

### DISCLOSURE OF THE INVENTION

### Problems to be Solved by the Invention

With the system disclosed in Patent Document 1, a third party can be prevented from tampering with data, but it is difficult to prevent data tampering by one of the sharers. Therefore, if a problem arises in the course of food distribution, this system gives rise to the possibility that one of the sharers tampers with data and makes it difficult to investigate the problem.

An example of an object of the present invention is to solve the foregoing issues by providing a data management apparatus, a data management method, and a computer-readable recording medium that can inhibit one of the sharers of shared data from tampering with the shared data.

### Means for Solving the Problems

To achieve the foregoing object, a data management apparatus according to one aspect of the present invention is for managing data shared by a plurality of users, and includes:

an encryption processing unit that encrypts the shared data;

a coordinate acquisition unit that, when one of the plurality of users has transmitted coordinates that have been pre-allocated thereto together with a request for decryption of the shared data, requests each of remaining users to transmit coordinates that have been pre-allocated thereto; and

a decryption processing unit that, when each of the remaining users has transmitted the coordinates that have been pre-allocated thereto, calculates a function from the coordinates transmitted by one user and the coordinates transmitted by the remaining users, and decrypts the encrypted shared data using a value obtained from the calculated function as a decryption key.

To achieve the foregoing object, a data management method according to another aspect of the present invention is for managing data shared by a plurality of users, and includes:

(a) a step of encrypting the shared data;

(b) a step of, when one of the plurality of users has transmitted coordinates that have been pre-allocated thereto together with a request for decryption of the shared data, requesting each of remaining users to transmit coordinates that have been pre-allocated thereto; and

(c) a step of, when each of the remaining users has transmitted the coordinates that have been pre-allocated thereto, calculating a function from the coordinates transmitted by one user and the coordinates transmitted by the remaining users, and decrypting the encrypted shared data using a value obtained from the calculated function as a decryption key.

To achieve the foregoing object, a computer-readable recording medium according to still another aspect of the present invention has recorded therein a program for managing data shared by a plurality of users using a computer, and the program includes an instruction for causing the computer to execute:

(a) a step of encrypting the shared data;

(b) a step of, when one of the plurality of users has transmitted coordinates that have been pre-allocated thereto together with a request for decryption of the shared data, requesting each of remaining users to transmit coordinates that have been pre-allocated thereto; and

(c) a step of, when each of the remaining users has transmitted the coordinates that have been pre-allocated thereto, calculating a function from the coordinates transmitted by one user and the coordinates transmitted by the remaining users, and decrypting the encrypted shared data using a value obtained from the calculated function as a decryption key.

### Advantageous Effects of the Invention

As described above, the present invention can inhibit one of the sharers of shared data from tampering with the shared data.

### BRIEF DESCRIPTION OF THE DRAWINGS

FIG. 1 is a block diagram schematically showing a configuration of a data management apparatus according to an embodiment of the present invention.

FIG. 2 is a block diagram showing the configuration of the data management apparatus according to the embodiment of the present invention in a specific manner.

FIG. 3 shows examples of a function and a decryption key calculated in the embodiment of the present invention.

FIG. 4 is a flowchart showing the operations of the data management apparatus according to the embodiment of the present invention.

FIG. 5 is a block diagram showing an example of a computer that realizes the data management apparatus according to the embodiment of the present invention.

### MODE FOR CARRYING OUT THE INVENTION

### Embodiment

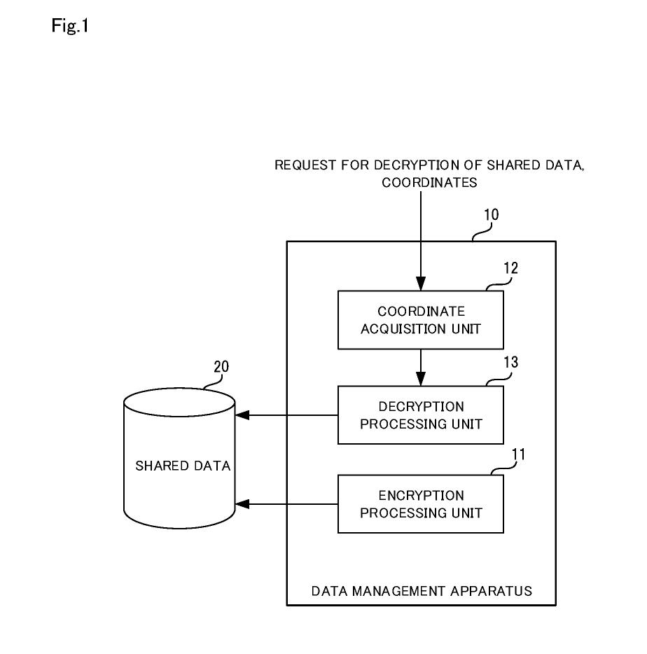

The following describes a data management apparatus, a data management method, and a program according to an embodiment of the present invention with reference to FIGS. 1 to 5.

### [Apparatus Configuration]

First, a configuration of the data management apparatus according to the present embodiment will be described using FIG. 1. FIG. 1 is a block diagram schematically showing the configuration of the data management apparatus according to the embodiment of the present invention.

A data management apparatus 10 according to the present embodiment, which is shown in FIG. 1, is for managing data 20 that is shared by a plurality of users (hereinafter, “shared data”). As shown in FIG. 1, the data management apparatus 10 includes an encryption processing unit 11, a coordinate acquisition unit 12, and a decryption processing unit 13. Among these units, the encryption processing unit 11 encrypts the shared data 20.

When one of the plurality of users has transmitted the coordinates that have been pre-allocated thereto together with a request for decryption of the shared data 20, the coordinate acquisition unit 12 requests each of the remaining users to transmit the coordinates that have been pre-allocated thereto.

When each of the remaining users has transmitted the coordinates that have been pre-allocated thereto, the decryption processing unit 13 calculates a function from the coordinates transmitted by one user and the coordinates transmitted by the remaining users. The decryption processing unit 13 then decrypts the encrypted shared data using a value obtained from the calculated function as a decryption key.

Accordingly, in the present embodiment, the shared data 20 can be decrypted only after the coordinates are acquired from all users. Furthermore, it is impossible for any user to calculate the function that serves as the source of the decryption key only by using the coordinates that they hold. Therefore, the present embodiment inhibits one of the sharers of the shared data 20 from tampering with the shared data 20.

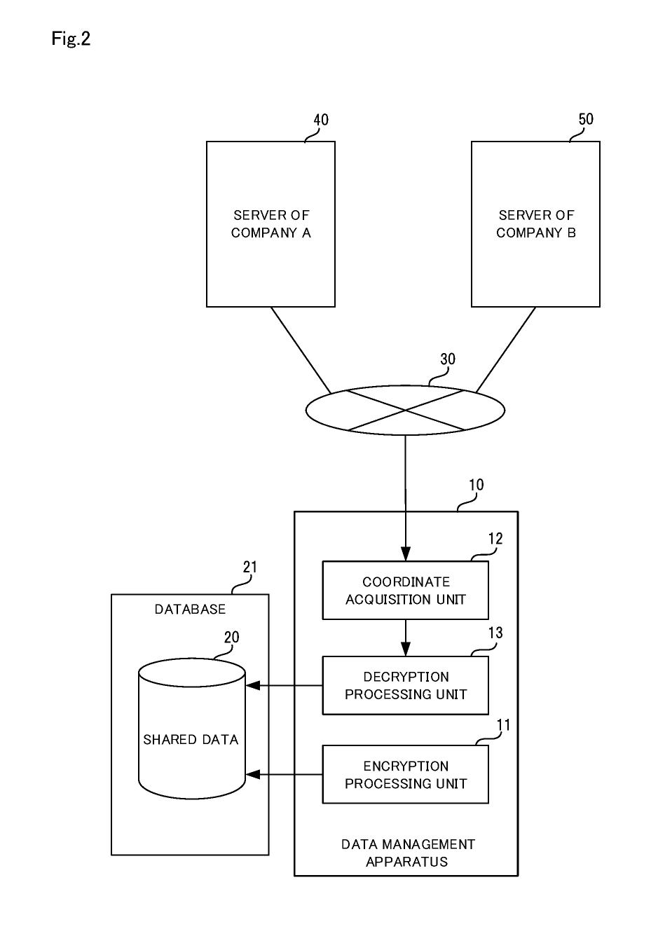

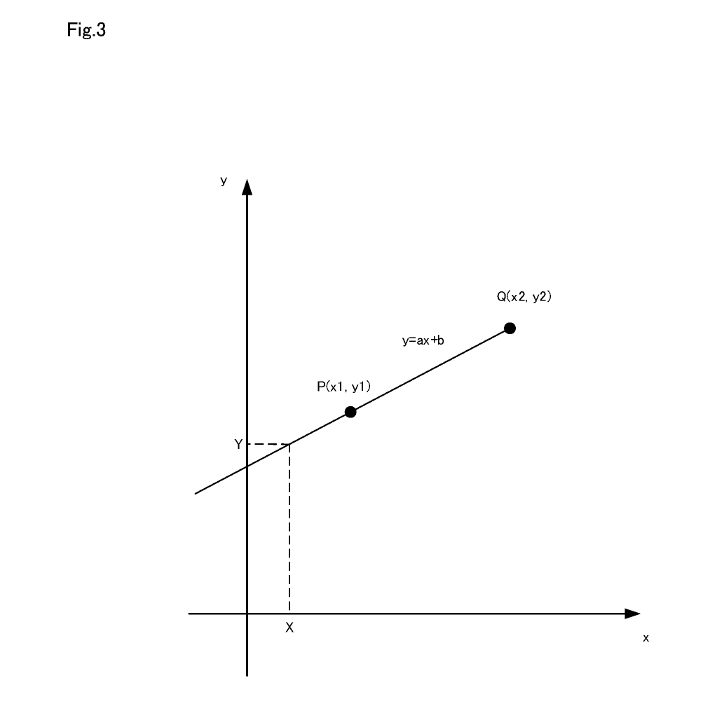

Below, the configuration of the data management apparatus 10 according to the present embodiment will be described in a more specific manner using FIGS. 2 and 3. FIG. 2 is a block diagram showing the configuration of the data management apparatus according to the embodiment of the present invention in a specific manner. FIG. 3 shows examples of the function and the decryption key calculated in the embodiment of the present invention.

As shown in FIG. 2, in the present embodiment, the data management apparatus 10 is connected to a server 40 of company A and a server 50 of company B via a network 30. Each of company A and company B is considered as a user. The shared data 20 is stored in a database 21.

In the present embodiment, as there are two users, namely company A and company B, the data management apparatus 10 acquires two sets of coordinates. Thus, the decryption processing unit 13 calculates a linear function expressed by y=ax+b. Note that a and b are arbitrary constants.

Specifically, each of the users, namely company A and company B, holds data of coordinates on a two-dimensional plane shown in FIG. 3. In an example of FIG. 3, company A holds the coordinates of point P (x1, y1), whereas company B holds the coordinates of point Q (x2, y2).

For example, when company A seeks to decrypt and update the shared data 20, the server 40 of company A transmits, to the data management apparatus 10, the coordinates of point P (x1, y1) together with a request for decryption of the shared data 20. Upon receiving the request and the coordinates of point P from company A, the coordinate acquisition unit 12 of the data management apparatus 10 requests the server 50 of company B to transmit the coordinates of point Q (x2, y2).

Once the server 50 of company B has transmitted the coordinates of point Q (x2, y2), the decryption processing unit 13 of the data management apparatus 10 calculates the linear function (y=ax+b) using the coordinates of point Q thus transmitted, and the coordinates of point P transmitted earlier.

The decryption processing unit 13 also calculates a value Y of y (or x) by substituting a preset value X of x (or y) into the calculated linear function, and decrypts the shared data 20 using the calculated value Y as the decryption key. Thereafter, the server 40 of company A updates the decrypted shared data 20.

Although the example of FIG. 3 illustrates a case in which two users share the data, the present embodiment is not limited in this way. The number of users may be three or more. That is to say, when the number of users is N, the decryption processing unit 13 calculates a polynomial function of degree (N−1) as the function, substitutes (N−1) variables of the calculated polynomial function of degree (N−1) with set values, and uses an obtained value of the remaining variable as the decryption key, where N is a natural number equal to or larger than two. Furthermore, in the present embodiment, the users are not limited to being “individuals,” and may be an “organizations” as in the examples of FIGS. 2 and 3.

### [Apparatus Operations]

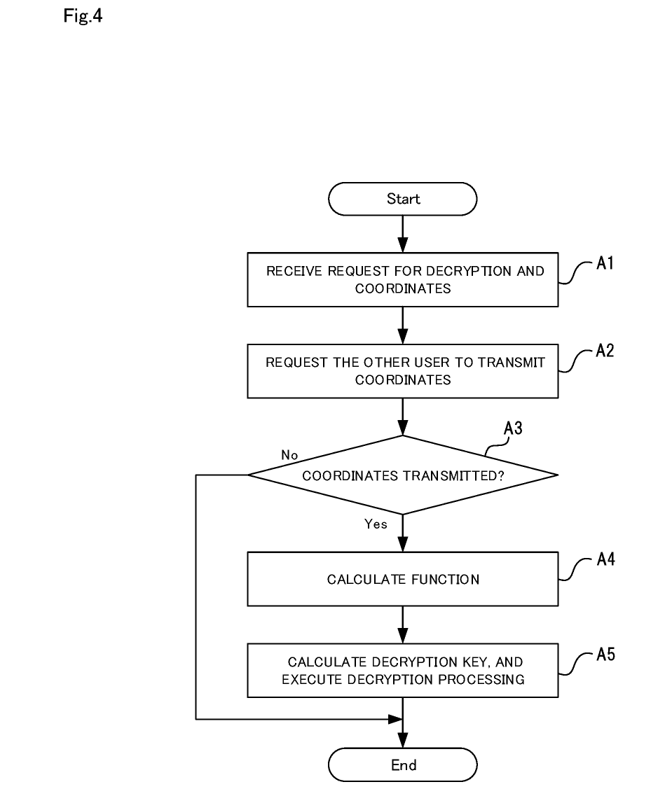

The operations of the data management apparatus 10 according to the embodiment of the present invention will now be described using FIG. 4. FIG. 4 is a flowchart showing the operations of the data management apparatus according to the embodiment of the present invention. In the following description, FIGS. 1 to 3 will be referred to as appropriate. In the present embodiment, the data management method is implemented by causing the data management apparatus 10 to operate. Therefore, the following description of the operations of the data management apparatus 10 applies to the data management method according to the present embodiment.

The following description will be given under the assumption that the shared data 20 stored in the database 21 has been encrypted by the encryption processing unit 11 of the data management apparatus 10 in advance, and that there are two users, namely company A and company B.

As shown in FIG. 4, first, when one of the server 40 of company A and the server 50 of company B has transmitted a request for decryption of the shared data 20 and the coordinates, the coordinate acquisition unit 12 of the data management apparatus 10 receives these request for decryption and coordinates (step A1).

Next, the coordinate acquisition unit 12 requests the other user to transmit the coordinates (step A2). Then, the coordinate acquisition unit 12 determines whether the other user has transmitted the coordinates held by the other user (step A3). Specifically, the coordinate acquisition unit 12 determines that the coordinates have been transmitted if the server of the other user has transmitted data of the coordinates. On the other hand, the coordinate acquisition unit 12 determines that the coordinates have not been transmitted if the server of the other user has not transmitted the data until the elapse of a set time period, or if the server of the other user has transmitted data indicating rejection of transmission of the coordinates.

If it is determined in step A3 that the other user has not transmitted the coordinates, it means that the other user has not agreed to update the shared data 20, and thus processing in the data management apparatus 10 ends.

On the other hand, if it is determined in step A3 that the other user has transmitted the coordinates, the coordinate acquisition unit 12 receives the transmitted coordinates and provides the decryption processing unit 13 with the coordinates of the other user thus received and the coordinates received earlier. Accordingly, the decryption processing unit 13 calculates the linear function (y=ax+b) using the two sets of coordinates received (step A4).

Next, the decryption processing unit 13 calculates a value of y (or x) by substituting a preset value of x (or y) into the linear function calculated in step A4, and decrypts the shared data 20 using the calculated value as the decryption key (step A5). Thereafter, the server that has requested the decryption updates the decrypted shared data 20.

As described above, the data management apparatus 10 shown in FIGS. 1 and 2 does not allow one of the users who share the database 21 to update the shared data unless the other user gives permission. This inhibits the occurrence of a situation in which one of the users tampers with the shared data 20 at their own discretion.

### [Program]

It is sufficient for the program according to the present embodiment to cause a computer to execute steps A1 to A5 shown in FIG. 4. The data management apparatus 10 and the data management method according to the present embodiment can be realized by installing this program in the computer and executing the installed program. In this case, a central processing unit (CPU) of the computer functions as the encryption processing unit 11, the coordinate acquisition unit 12, and the decryption processing unit 13, and executes processing.

In the present embodiment, the database 21 can be realized by storing a data file that composes the database 21 to a hard disk or a similar storage device provided in the computer. The storage device that realizes the database 21 may be realized by loading a recording medium having stored therein this data file to a reading apparatus connected to the computer.

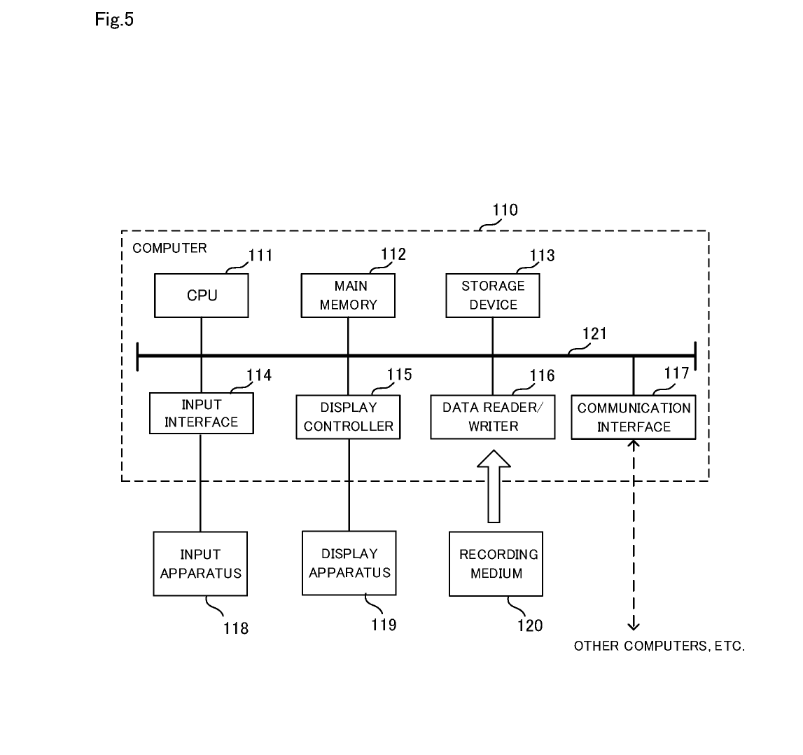

Using FIG. 5, a description is now given of the computer that realizes the data management apparatus 10 by executing the program according to the present embodiment. FIG. 5 is a block diagram showing an example of the computer that realizes the data management apparatus according to the embodiment of the present invention.

As shown in FIG. 5, a computer 110 includes a CPU 111, a main memory 112, a storage device 113, an input interface 114, a display controller 115, a data reader/writer 116, and a communication interface 117. These components are connected in such a manner that they can perform data communication with one another via a bus 121.

The CPU 111 performs various types of calculation by deploying the program (code) according to the present embodiment stored in the storage device 113 to the main memory 112, and executing the deployed program in a predetermined order. The main memory 112 is typically a volatile storage device, such as a dynamic random-access memory (DRAM). The program according to the present embodiment is provided while being stored in a computer-readable recording medium 120. The program according to the present embodiment may be distributed over the Internet connected via the communication interface 117.

Specific examples of the storage device 113 include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120. The data reader/writer 116 reads out the program from the recording medium 120, and writes the result of processing of the computer 110 to the recording medium 120. The communication interface 117 mediates data transmission between the CPU 111 and other computers.

Specific examples of the recording medium 120 include: a general-purpose semiconductor storage device, such as CompactFlash® (CF) and Secure Digital (SD); a magnetic storage medium, such as a flexible disk; and an optical storage medium, such as a compact disc read-only memory (CD-ROM).

### INDUSTRIAL APPLICABILITY

As described above, the present invention can inhibit one of the sharers of shared data from tampering with the shared data. The present invention is useful in a system in which a plurality of users share data.

A part or an entirety of the foregoing embodiment can be described as, but is not limited to, the following Supplementary Notes 1 to 6.

### (Supplementary Note 1)

A data management apparatus for managing data shared by a plurality of users, the data management apparatus including:

an encryption processing unit that encrypts the shared data;

a coordinate acquisition unit that, when one of the plurality of users has transmitted coordinates that have been pre-allocated thereto together with a request for decryption of the shared data, requests each of remaining users to transmit coordinates that have been pre-allocated thereto; and

a decryption processing unit that, when each of the remaining users has transmitted the coordinates that have been pre-allocated thereto, calculates a function from the coordinates transmitted by the one user and the coordinates transmitted by the remaining users, and decrypts the encrypted shared data using a value obtained from the calculated function as a decryption key.

### (Supplementary Note 2)

The data management apparatus according to Supplementary Note 1, wherein

when the number of the plurality of users is N, the decryption processing unit calculates a polynomial function of degree (N−1) as the function, substitutes (N−1) variables of the calculated polynomial function of degree (N−1) with set values, and uses an obtained value of a remaining variable as the decryption key.

### (Supplementary Note 3)

A data management method for managing data shared by a plurality of users, the data management method including:

(a) a step of encrypting the shared data;

(b) a step of, when one of the plurality of users has transmitted coordinates that have been pre-allocated thereto together with a request for decryption of the shared data, requesting each of remaining users to transmit coordinates that have been pre-allocated thereto; and

(c) a step of, when each of the remaining users has transmitted the coordinates that have been pre-allocated thereto, calculating a function from the coordinates transmitted by the one user and the coordinates transmitted by the remaining users, and decrypting the encrypted shared data using a value obtained from the calculated function as a decryption key.

### (Supplementary Note 4)

The data management method according to Supplementary Note 3, wherein when the number of the plurality of users is N, step (c) calculates a polynomial function of degree (N−1) as the function, substitutes (N−1) variables of the calculated polynomial function of degree (N−1) with set values, and uses an obtained value of a remaining variable as the decryption key.

### (Supplementary Note 5)

A computer-readable recording medium having recorded therein a program for managing data shared by a plurality of users using a computer, the program including an instruction for causing the computer to execute:

(a) a step of encrypting the shared data;

(b) a step of, when one of the plurality of users has transmitted coordinates that have been pre-allocated thereto together with a request for decryption of the shared data, requesting each of remaining users to transmit coordinates that have been pre-allocated thereto; and

(c) a step of, when each of the remaining users has transmitted the coordinates that have been pre-allocated thereto, calculating a function from the coordinates transmitted by the one user and the coordinates transmitted by the remaining users, and decrypting the encrypted shared data using a value obtained from the calculated function as a decryption key.

### (Supplementary Note 6)

The computer-readable recording medium according to Supplementary Note 5, wherein

when the number of the plurality of users is N, step (c) calculates a polynomial function of degree (N−1) as the function, substitutes (N−1) variables of the calculated polynomial function of degree (N−1) with set values, and uses an obtained value of a remaining variable as the decryption key.

Although the invention of the present application has been described thus far with reference to the embodiment, the invention of the present application is not limited to the foregoing embodiment. Various changes that can be understood by a person skilled in the art can be made to the configurations and details of the invention of the present application within the scope of the invention of the present application.

The present application claims the benefit of priority from Japanese Patent Application No. 2015-066878, filed Mar. 27, 2015, the disclosure of which is incorporated herein by reference in its entirety.

### REFERENCE SIGNS LIST

10 data management apparatus
11 encryption processing unit
12 coordinate acquisition unit
13 decryption processing unit
20 shared data
21 database
30 network
40, 50 server
110 computer
111 CPU
112 main memory
113 storage device
114 input interface
115 display controller
116 data reader/writer
117 communication interface
118 input apparatus
119 display apparatus
120 recording medium
121 bus

What is claimed is:

1. A data management apparatus for managing data shared by a plurality of users, the data management apparatus comprising:
an encryption processing unit that encrypts the shared data;
a coordinate acquisition unit that, when one of the plurality of users has transmitted coordinates that have been pre-allocated thereto together with a request for decryption of the shared data, requests each of remaining users to transmit coordinates that have been pre-allocated thereto; and
a decryption processing unit that, when each of the remaining users has transmitted the coordinates that have been pre-allocated thereto, calculates a function from the coordinates transmitted by the one user and the coordinates transmitted by the remaining users, and decrypts the encrypted shared data using a value obtained from the calculated function as a decryption key.

2. The data management apparatus according to claim 1, wherein
when the number of the plurality of users is N, the decryption processing unit calculates a polynomial function of degree (N−1) as the function, substitutes (N−1) variables of the calculated polynomial function of degree (N−1) with set values, and uses an obtained value of a remaining variable as the decryption key.

3. A data management method for managing data shared by a plurality of users, the data management method comprising:
(a) a step of encrypting the shared data;
(b) a step of, when one of the plurality of users has transmitted coordinates that have been pre-allocated thereto together with a request for decryption of the shared data, requesting each of remaining users to transmit coordinates that have been pre-allocated thereto; and
(c) a step of, when each of the remaining users has transmitted the coordinates that have been pre-allocated thereto, calculating a function from the coordinates transmitted by the one user and the coordinates transmitted by the remaining users, and decrypting the encrypted shared data using a value obtained from the calculated function as a decryption key.

4. The data management method according to claim 3, wherein
when the number of the plurality of users is N, step (c) calculates a polynomial function of degree (N−1) as the function, substitutes (N−1) variables of the calculated polynomial function of degree (N−1) with set values, and uses an obtained value of a remaining variable as the decryption key.

5. A non transitory computer-readable recording medium having recorded therein a program for managing data shared by a plurality of users using a computer, the program including an instruction for causing the computer to execute:
(a) a step of encrypting the shared data;
(b) a step of, when one of the plurality of users has transmitted coordinates that have been pre-allocated thereto together with a request for decryption of the shared data, requesting each of remaining users to transmit coordinates that have been pre-allocated thereto; and
(c) a step of, when each of the remaining users has transmitted the coordinates that have been pre-allocated thereto, calculating a function from the coordinates transmitted by the one user and the coordinates transmitted by the remaining users, and decrypting the encrypted shared data using a value obtained from the calculated function as a decryption key.

6. The non transitory computer-readable recording medium according to claim 5, wherein
when the number of the plurality of users is N, step (c) calculates a polynomial function of degree (N−1) as the function, substitutes (N−1) variables of the calculated polynomial function of degree (N−1) with set values, and uses an obtained value of a remaining variable as the decryption key.
